(19) United States
(12) Patent Application Publication
(10) Pub. No.: US 2018/0279372 A1
(43) Pub. Date: Sep. 27, 2018

(54) USER TERMINAL, RADIO BASE STATION, RADIO COMMUNICATION SYSTEM AND RADIO COMMUNICATION METHOD

(71) Applicant: NTT DOCOMO, INC., Tokyo (JP)

(72) Inventors: Kazuki Takeda, Tokyo (JP); Hiroki Harada, Tokyo (JP); Shimpei Yasukawa, Tokyo (JP); Satoshi Nagata, Tokyo (JP)

(73) Assignee: NTT DOCOMO, INC., Tokyo (JP)

(21) Appl. No.: 15/524,361

(22) PCT Filed: Oct. 9, 2015
(86) PCT No.: PCT/JP2015/078739

§ 371 Date: May 4, 2017

(30) Foreign Application Priority Data
Nov. 6, 2014 (JP) 2014-225846

(51) Int. Cl. H04W 74/08; H04W 16/14; H04W 72/04; H04W 72/12

(52) U.S. Cl. CPC H04W 74/0833; H04W 72/1268; H04W 72/042; H04W 16/14

(57) ABSTRACT

The present invention is designed to adequately carry out uplink communication in unlicensed bands in a radio communication system (LAA) that runs LTE in unlicensed bands. A user terminal has a control section that controls the transmission and receipt of a signal in a first frequency carrier in which LBT (Listen Before Talk) is configured or in a second frequency carrier in which LBT is not configured, and the control section controls the step of receiving a random access response and subsequent steps in random access procedures to be performed in the second frequency carrier, and, furthermore, controls uplink transmission to be carried out in the first frequency carrier after random access is established.

### TECHNICAL FIELD

The present invention relates to a user terminal, a radio base station, a radio communication system and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). The specifications of LTE-advanced have been already drafted for the purpose of achieving further broadbandization and higher speeds beyond LTE, and, in addition, for example, a successor system of LTE—referred to as “FRA” (future radio access)—is under study.

In LTE of Rel. 8 to 12, the specifications have been drafted assuming exclusive operations in frequency bands that are licensed to operators—that is, licensed bands. For licensed bands, for example, 800 MHz, 2 GHz and/or 1.7 GHz have been in use.

LTE of Rel. 13 and later versions, which is under study, targets also on operations in frequency bands where license is not required—that is, unlicensed bands. For unlicensed band, for example, 2.4 GHz, which is the same as in Wi-Fi, or the 5 GHz band and/or the like may be used. Although carrier aggregation (LAA: license-assisted access) between licensed bands and unlicensed bands is under study in Rel. 13 LTE, there is a possibility that, in the future, dual connectivity and unlicensed-band stand-alone may be studied as well.

In unlicensed bands, interference control functionality is likely to be necessary in order to allow co-presence with other operators' LTE, Wi-Fi, or different systems. In Wi-Fi, the function called “LBT” (Listen Before Talk) or “CCA” (Clear Channel Assessment) is implemented as an interference control function.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall description; Stage 2”

### SUMMARY OF INVENTION

### Technical Problem

The method of allowing uplink communication by using unlicensed bands in a radio communication system (LAA) to run LTE in unlicensed bands (LAA) has not been stipulated heretofore.

The present invention has been made in view of the above, and it is therefore an object of the present invention to provide a user terminal, a radio base station, a radio communication system and a radio communication method, whereby uplink communication can be adequately carried out in unlicensed bands in a radio communication system (LAA) that runs LTE in unlicensed bands.

### Solution to Problem

According to the present invention, a user terminal has a control section that controls the transmission and receipt of a signal in a first frequency carrier in which LBT (Listen Before Talk) is configured or in a second frequency carrier in which LBT is not configured, and the control section controls the step of receiving a random access response and subsequent steps in random access procedures to be performed in the second frequency carrier, and, furthermore, controls uplink transmission to be carried out in the first frequency carrier after random access is established.

### Advantageous Effects of Invention

According to the present invention, it is possible to adequately carry out uplink communication in unlicensed bands in a radio communication system (LAA) that runs LTE in unlicensed bands.

### BRIEF DESCRIPTION OF DRAWINGS

FIG. 1 is a diagram to explain LBT in Wi-Fi;

FIG. 2 is a diagram to explain random access procedures;

FIG. 3 is a diagram to explain random access procedures according to a second example;

FIG. 4 is a diagram to show an example of a schematic structure of a radio communication system according to the present embodiment;

FIG. 5 is a diagram to show an example of an overall structure of a radio base station according to the present embodiment;

FIG. 6 is a diagram to show an example of a functional structure of a radio base station according to the present embodiment;

FIG. 7 is a diagram to show an example of an overall structure of a user terminal according to the present embodiment; and

FIG. 8 is a diagram to show an example of a functional structure of a user terminal according to the present embodiment.

### DESCRIPTION OF EMBODIMENTS

Now, an embodiment of the present invention will be described in detail below with reference to the accompanying drawings. Although an example case will be described below with the present embodiment where the frequency carrier to trans uplink signals is an unlicensed band, the target to apply the present invention to is by no means limited to unlicensed bands. Although the present embodiment will be described assuming that a frequency carrier in which LBT is not configured is a licensed band and a frequency carrier in which LBT is configured is an unlicensed band, this is by no means limiting. That is, the present embodiment is applicable to any frequency carrier in which LBT is configured, regardless of whether this is a licensed band or an unlicensed band.

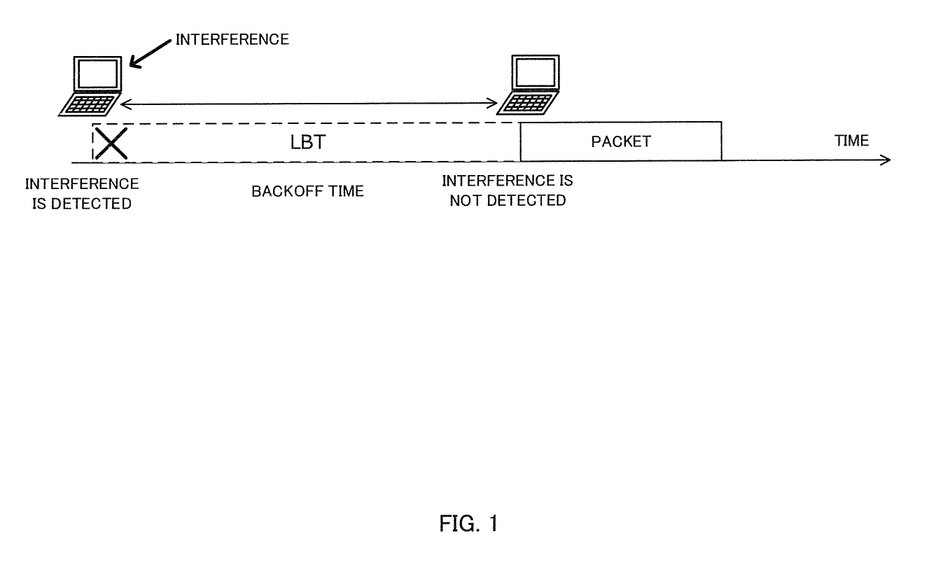

In Wi-Fi, LBT (Listen Before Talk) or CCA (Clear Channel Assessment) is used as an interference control function in unlicensed bands. An example of LBT or CCA in Wi-Fi will be described with reference to FIG. 1. Before starting communicating, a communication terminal tries to receive and detect signals for a predetermined period of time, in order to see whether other devices are transmitting signals in the frequency in which the communication terminal plans transmission. When signals from other devices are detected, the communication terminal holds the transmission, and, after a predetermined period of time passes, the user terminal carries out the transmission at a timing where no signals from other devices are detected and transmission is judged to be possible.

In LAA systems, it may be possible to control whether or not transmission is made based on the result of listening, as in Wi-Fi systems. Here, if received signal intensity that is higher than a predetermined threshold is detected during the LBT period, the channel is judged to be in the busy state (LBT_{busy}). If the received signal intensity during the LBT period is lower than the predetermined threshold, the channel is judged to be in the idle state (LBT_{idle}).

In LTE systems, random access is made by transmitting a physical random access channel (PRACH) on the uplink when establishing initial connection, when establishing synchronization, when resuming communication and so on. Random access can be classified into two types—namely, contention-based random access and non-contention-based random access.

In contention-based random access, user terminals transmit preambles, which are selected randomly from a plurality of random access preambles prepared within a cell, by using PRACHs. In this case, there is a possibility that the same random access preamble is used between user terminals and creates contention.

In non-contention-based random access, user terminals transmit terminal-specific random access preambles, which are allocated by the network in advance, by using PRACHs. In this case, contention is not created because different random access preambles are allocated between the user terminals.

Contention-based random access is used when establishing initial connection, when starting or resuming uplink communication, and so on. Non-contention-based random access is used when conducting a handover, when starting or resuming downlink communication, and so on.

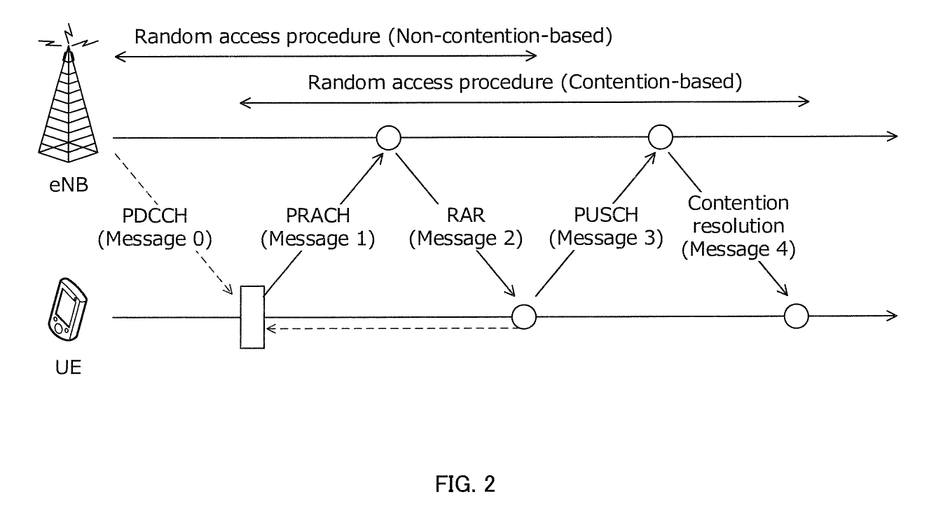

FIG. 2 shows an overview of random access. Contention-based random access is comprised of step 1 to step 4. Non-contention-based random access is comprised of step 0 to step 2.

In contention-based random access, first, a user terminal transmits a random access preamble by using a PRACH resource that is configured in the residing cell (message 1). A radio base station, upon detecting the random access preamble, transmits a random access response (RAR), which is information in response to that (message 2). After having transmitted the random access preamble, the user terminal tries to receive the random access response (message 2) in a predetermined period. When the user terminal fails to receive message 2, the user terminal raises the transmission power of the PRACH and transmits message 1 again.

When receiving the random access response, the user terminal transmits a data signal (message 3) by using the physical uplink shared channel (PUSCH) that is specified by an uplink scheduling grant that is included in the random access response. The radio base station, upon receiving message 3, transmits a contention resolution message to the user terminal (message 4). The user terminal identifies the radio base station by establishing synchronization using messages 1 to 4, and thereupon finishes the contention-based random access procedures and establishes a connection.

In the event of non-contention-based random access, first, a radio base station transmits a physical downlink control channel (PDCCH) to command a user terminal to transmit a PRACH (message 0). The user terminal transmits a random access preamble (PRACH) at the timing specified by the PDCCH (message 1). The radio base station, upon detecting the random access preamble, transmits a random access response (RAR), which is information in response to that (message 2). The user terminal finishes the non-contention-based random access procedures upon receipt of message 2. Note that, as in contention-based random access, when the user terminal fails to receive message 2, the user terminal raises the transmission power of the PRACH and transmits message 1 again.

However, in unlicensed bands in LAA, it is difficult to execute the above-described conventional random access. Because of the overhead, generally, PRACHs can be transmitted in limited resources, such as once in every 10 ms or 20 ms. Consequently, resources (subframes) in which PRACHs can be transmitted are limited. When LBT_{busy} is yielded in an unlicensed band, it is a long way to the next transmission opportunity, and the impact of this delay damages the throughput.

In an unlicensed band, LBT is required every time message 1, 2, 3 or 4 is exchanged in the event of contention-based random access, or every time message 0, 1 or 2 is exchanged in the event of non-contention-based random access. When LBT_{busy} is yielded while these messages are exchanged, random access fails, and it is necessary to re-try random access from the beginning.

In this way, the problem lies in how to efficiently allow uplink communication in LAA unlicensed bands.

In view of the above, the present inventors have found out configurations for allowing uplink communication in LAA unlicensed bands. To be more specific, in order to allow uplink communication in LAA unlicensed bands, the present inventors have arrived at a mode in which random access is not used in unlicensed band CCs (first example), and a mode in which random access is used in unlicensed band CCs (second example).

### First Example

With the first example, to allow uplink communication in LAA unlicensed bands, random access is not used in unlicensed band component carriers (CCs). That is, according to the first example, random access is used only in licensed band CCs.

An unlicensed band CC can be included in the same TAG (timing advance group) with a licensed band CC. A radio base station can configure each TAG of a user terminal to include at least one licensed band CC. The user terminal assumes that uplink transmission timings are the same among all the CCs in a TAG. It then follows that, once random access is executed in a given CC in a TAG, it is possible to assume that uplink timing synchronization is established in all the CCs in the same TAG, and that random access needs not be executed in the other CCs. As a result, when the user terminal uplink synchronization by executing random access procedures in a licensed band CC in a TAG, the user terminal can perform uplink transmission in an unlicensed band CC as well.

The user terminal assumes that all the CCs configured in the same TAG share the same uplink transmission timings and that the receiving timings in the downlink are also the same. The user terminal sees a specific cell in a TAG as a timing reference cell and detects a receiving timing in the downlink. Furthermore, based on this downlink receiving timing, the user terminal determines the point in time to start random access procedures—that is, the timing to transmit a random access preamble. The radio base station transmits a timing advance (TA) command to the user terminal based on the timing the random access preamble transmitted from the user terminal is received, and control the transmission timing of the user terminal. Note that, when the downlink receiving timing of the timing reference cell shifts, the user terminal may autonomously control and correct the transmission timing in accordance with that shift.

Since, as described earlier, the radio base station configures licensed band CCs and unlicensed band CCs to be included in the same TAG for a user terminal, random access procedures can be executed in licensed bands. However, there are cases where the timing reference cell to provide a reference downlink receiving timing is not configured in a licensed band CC. In this case, the problem arises that, due to LBT_{busy}, downlink reference signals cannot be received adequately, and downlink timings cannot be detected accurately. Now, cases where such a problem arises will be described below.

Conventionally, in a TAG (PTAG) that includes a primary cell (PCell), the PCell is the timing reference cell, and, in a TAG (PSTAG) that includes a primary-secondary cell (PSCell), the PSCell is the timing reference cell. Consequently, in a PTAG and a PSTAG, it is possible to make the timing reference cell a licensed band CC by configuring a licensed band CC as a PCell or a PSCell, and this makes it easy to establish uplink synchronization in random access procedures. The PCell refers to the cell that manages RRC connection, handover and so on when carrier aggregation or dual connectivity is used, and is also a cell that requires uplink communication in order to receive data and feedback signals from user terminals. A PSCell refers to an SCell that has equivalent functions to those of a PCell.

However, conventionally, in a TAG (STAG) that includes neither a PCell not a PSCell, a user terminal can make an arbitrary cell the timing reference cell. Consequently, in an STAG, even when at least one licensed band CC is configured and the cells to be subject to random access procedures are limited to licensed band CCs alone, there is still a possibility that a user terminal selects an unlicensed band CC as the timing reference cell and is unable to establish uplink synchronization properly.

So, the user terminal is allowed to receive control information for distinguishing between licensed band CCs and unlicensed band CCs. As a method of reporting such control information, for example, it may be possible to use higher layer signaling such as broadcast information, RRC signaling and so on. The specific content of the control information may be, for example, information as to whether each CC is a licensed band CC or an unlicensed band CC. In this way, by enabling a user terminal to distinguish between licensed band CCs and unlicensed band CCs, it is possible to allow the user terminal to select a licensed band CC in an STAG as the timing reference cell, and improve the reliability of uplink synchronization establishment. Also, the timing reference cell is also used in synchronous tracking after uplink synchronization is established. Since, unlike an unlicensed band CC, LBT_{busy} is not yielded in a licensed band CC, and downlink reference signals can be always received, so that it is possible to heighten the performance of synchronous tracking during communication as well.

Furthermore, due to the difference in terms of the absence/presence of LBT_{busy}, between licensed band CCs and unlicensed band CCs, the steps of measurements and the level of accuracy required, or the steps of channel quality (CSI: channel state information) measurements and the level of accuracy required, may be different. However, by reporting control information for distinguishing between licensed band CCs and unlicensed band CCs to a user terminal as described above, in both licensed band CCs and unlicensed band CC the user terminal can perform measurements that are suitable to these, CSI measurements, and so on.

In this way, when a user terminal receives the above control information for distinguishing between licensed band CCs and unlicensed band CCs, the user terminal may configure an arbitrary licensed band CC as the timing reference cell for timing control in each TAG.

In a TAG, TA commands may also be transmitted from a licensed band CC in MAC CEs (MAC control elements). In other words, a user terminal does not receive TA commands in MAC CEs in unlicensed band CCs in this TAG.

In this TAG, the user terminal may execute autonomous timing control based on a downlink receiving timing in a licensed band CC.

It is equally possible to report control information that makes it clear whether or not LBT is configured in each CC, instead of control information that differentiates between licensed band CCs and unlicensed band CCs. Here, when “LBT is configured,” this refers to a CC in which radio base stations or user terminals execute LBT. In this case, a CC in which LBT is configured and a CC in which LBT is not configured may be configured for a user terminal by using higher layer signaling such as broadcast information, RRC signaling and so on. By this means, flexible operation is made possible, and the rule that LBT is to be always executed in licensed bands and that LBT is never to be executed in unlicensed bands no longer applies. For example, when a shared band—that is, a frequency that is shared between varying radio access systems (RATS)—is used, there is a possibility that even a licensed band requires LBT. In this case, by reporting this band to a user terminal as a CC in which LBT is configured, it is possible to execute adequate control as in an unlicensed band CC.

In this case, the radio base station configures at least one CC in which LBT is not configured to be included in the same TAG with the CC in which LBT is configured, for a user terminal. Furthermore, the radio base station limits the CCs in which the user terminal performs random access procedures to CCs in which LBT is not configured. The user terminal can configure a CC in which LBT is not configured as the timing reference cell, and, furthermore, performs random access procedures in CCs in which LBT is not configured, so that it is possible to improve the reliability of uplink synchronization. The user terminal may send capability signaling as to whether or not the user terminal is capable of executing LBT in a predetermined frequency band, to the network, in advance.

### Second Example

With a second example, to allow uplink communication in LAA unlicensed bands, random access is used in unlicensed band CCs as well. That is, according to the second example, random access is used in both licensed band CCs and unlicensed band CCs.

The following description will encompass contention-based random access. Conventionally, if non-contention-based random access is used, a radio base station can send messages 0, 2 and 4 in a licensed band CC by using the mechanism of cross-carrier scheduling. For example, it is possible to specify the SCell to transmit message 1 in message 0, and transmit message 2 from a PCell (common search space). However, when non-contention-based random access is used, a case might occur where LBT_{busy} is yielded due to a PDCCH trigger, and message 1 cannot be transmitted. In this way, non-contention-based random access has a threat of producing significant delays before random access is established.

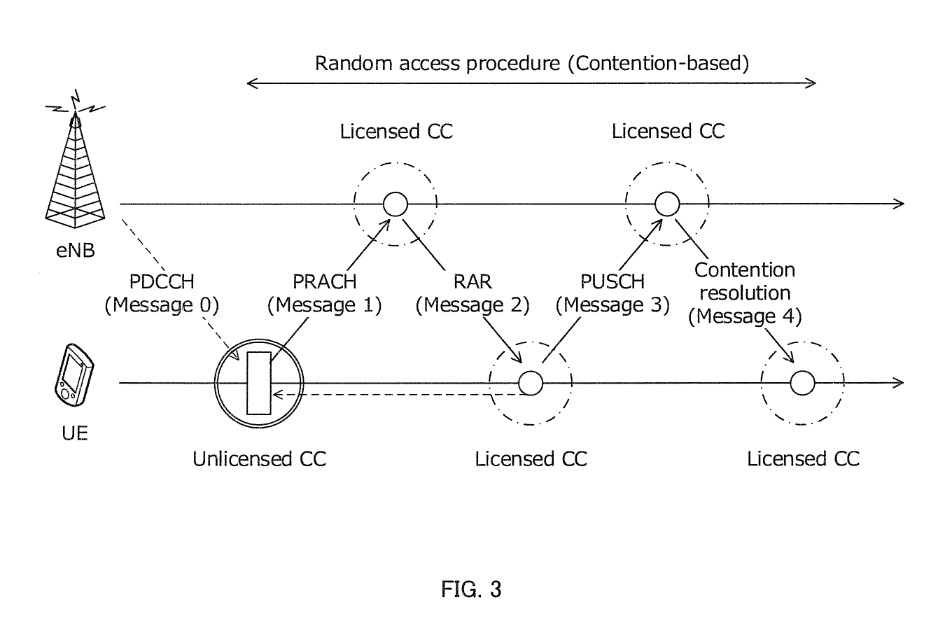

To be more specific, a user terminal transmits only message 1 in an unlicensed band CC, in contention-based random access procedures (see FIG. 3). That is, message 2, 3 and 4 are transmitted in a licensed band CC. By transmitting only message 1, which is transmitted based on the user terminal's decision, in an unlicensed band CC, it is possible to establish uplink synchronization, and, furthermore, since messages 2, 3 and 4 are transmitted in a licensed band CC, it is possible to avoid failing transmitting these due to LBT_{busy} and re-trying random access procedures. After random access is established, uplink transmission in the unlicensed band CC is started.

According to this method, it becomes possible to minimize the impact of LBT results and complete random access procedures in unlicensed band CCs. Since a user terminal transmits message 1 in its own timing, even when a case occurs in which transmission is disabled due to LBT_{busy}, a radio base station does not see this as a delay. Random access procedures are started at a timing a user terminal decides on LBT_{idle} and transmits a PRACH, and, after this, it is possible to complete random access procedures without being influenced by the result of LBT result.

To be more specific, it is possible to configure resources that can be used to transmit contention-based PRACHs, in an unlicensed band CC, in advance, by higher layer signaling. When the user terminal has to transmit a PRACH, the user terminal first executes LBT, and transmits message 1 if LBT_{idle} is yielded, or postpones the transmission of message 1 if LBT_{busy} is yielded. After transmitting message 1, the user terminal tries to receive message 2 in a common search space in a predetermined period of time. The common search space is included in the PCell or a PSCell in a licensed band CC. When the user terminal successfully receives message 2, the user terminal transmits message 3 following its command. The subsequent steps are the same as in normal random access. However, messages 2, 3 and 4 are sent, for example, in the licensed band CC that is configured as the PCell.

As in the first example, it is also possible to signal control information for distinguishing between licensed band CCs and unlicensed band CCs, or information about CCs in which LBT is configured and CCs in which LBT is not configured, to user terminals.

(Structure of Radio Communication System)

Now, the structure of the radio communication system according to the present embodiment will be described below. In this radio communication system, a radio communication method to perform the above-described random access procedures is employed.

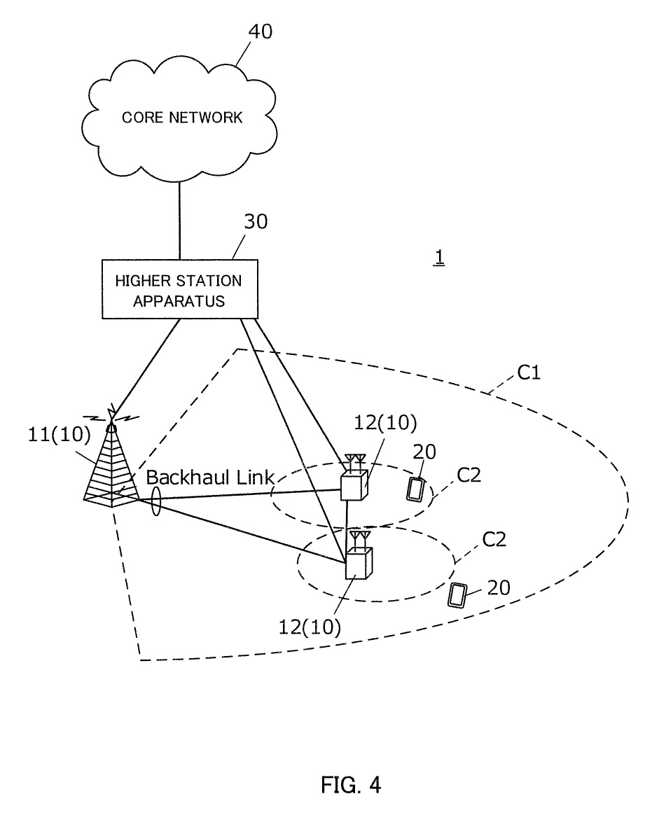

FIG. 4 is schematic structure diagram to show an example of a radio communication system according to the present embodiment. This radio communication system can adopt one or both of carrier aggregation (CA), which groups a plurality of fundamental frequency blocks (component carriers) into one, where the LTE system bandwidth constitutes one unit, and dual connectivity (DC). Also, this radio communication system provides a radio base station that can use unlicensed bands.

As shown in FIG. 4, a radio communication system 1 is comprised of a plurality of radio base stations 10 (11 and 12), and a plurality of user terminals 20 that are present within cells formed by each radio base station 10 and that are configured to be capable of communicating with each radio base station 10. The radio base stations 10 are each connected with a higher station apparatus 30, and are connected to a core network 40 via the higher station apparatus 30.

In FIG. 4, the radio base station 11 is, for example, a macro base station having a relatively wide coverage, and forms a macro cell C1. The radio base stations 12 are, for example, small base stations having local coverages, and form small cells C2. Note that the number of radio base stations 11 and 12 is not limited to that shown in FIG. 4.

For example, a mode may be possible in which the macro cell C1 is used in a licensed band and the small cells C2 are used in unlicensed bands. Also, a mode may be also possible in which part of the small cells C2 is used in a licensed band and the rest of the small cells C2 are used in unlicensed bands. The radio base stations 11 and 12 are connected with each other via an inter-base station interface (for example, optical fiber, the X2 interface, etc.).

The user terminals 20 can connect with both the radio base station 11 and the radio base stations 12. The user terminals 20 may use the macro cell C1 and the small cells C2, which use different frequencies, at the same time, by way of carrier aggregation or dual connectivity. For example, it is possible to transmit assist information (for example, the DL signal configuration) related to a radio base station 12 that uses an unlicensed band, from the radio base station 11 that uses a licensed band, to the user terminals 20. Also, a structure may be employed here in which, when carrier aggregation is used between a licensed band and an unlicensed band, one radio base station (for example, the radio base station 11) controls the scheduling of licensed band cells and unlicensed band cells.

The user terminals 20 may be structured to connect with radio base stations 12, without connecting with the radio base station 11. For example, a radio base station 12 to use an unlicensed band may be structured to connect with a user terminal 20 in stand-alone. In this case, the radio base station 12 controls the scheduling of unlicensed band cells.

The higher station apparatus 30 may be, for example, an access gateway apparatus, a radio network controller (RNC), a mobility management entity (MME) and so on, but is by no means limited to these.

In the radio communication system 1, a downlink shared channel (PDSCH: Physical Downlink Shared CHannel), which is used by each user terminal 20 on a shared basis, a downlink control channel (PDCCH (Physical Downlink Control CHannel), EPDCCH (Enhanced Physical Downlink Control CHannel), etc.), a broadcast channel (PBCH) and so on are used as downlink channels. User data, higher layer control information and predetermined SIBs (System Information Blocks) are communicated in the PDSCH. Downlink control information (DCI) is communicated using the PDCCH and/or the EPDCCH.

Also, in the radio communication system 1, an uplink shared channel (PUSCH: Physical Uplink Shared CHannel), which is used by each user terminal 20 on a shared basis, an uplink control channel (PUCCH: Physical Uplink Control CHannel) and so on are used as uplink channels. User data and higher layer control information are communicated by the PUSCH.

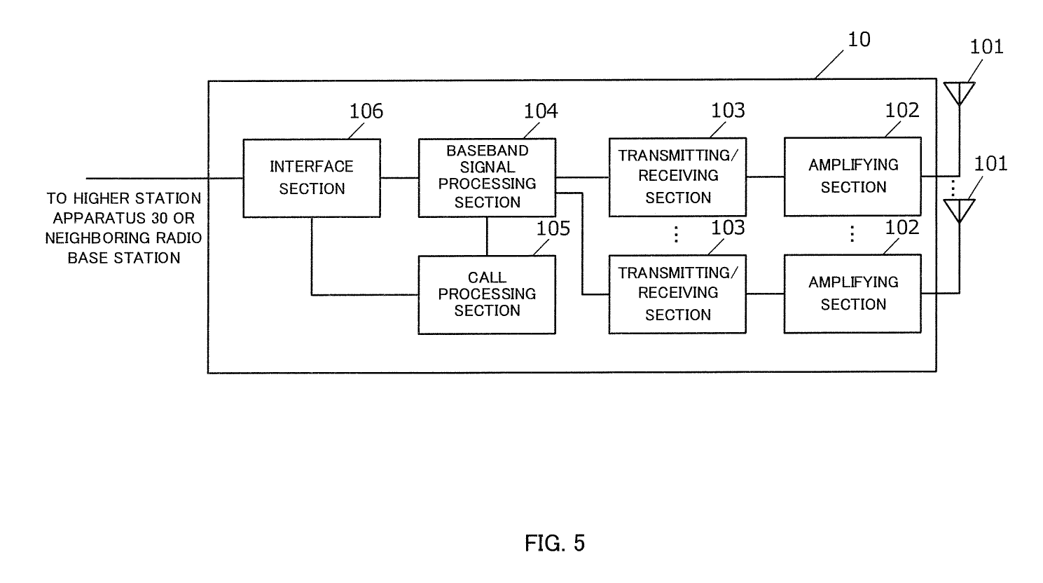

FIG. 5 is a diagram to show an overall structure of a radio base station 10 according to the present embodiment. As shown in FIG. 5, the radio base station 10 has a plurality of transmitting/receiving antennas 101 for MIMO (Multiple Input Multiple Output) communication, amplifying sections 102, transmitting/receiving sections (transmitting sections and receiving sections) 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, the user data is subjected to a PDCP (Packet Data Convergence Protocol) layer process, user data division and coupling, RLC (Radio Link Control) layer transmission processes such as an RLC retransmission control transmission process, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts the downlink signals, which are pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101. For the transmitting/receiving sections 103, transmitters/receivers, transmitting/receiving circuits or transmitting/receiving devices that can be described based on common understanding of the technical field to which the present invention pertains can be used.

As for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, user data that, is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The interface section 106 transmits and receives signals to and from neighboring radio base stations (backhaul signaling) via an inter-base station interface (for example, optical fiber, the X2 interface, etc.). Alternatively, the interface section 106 transmits and receives signals to and from the higher station apparatus 30 via a predetermined interface.

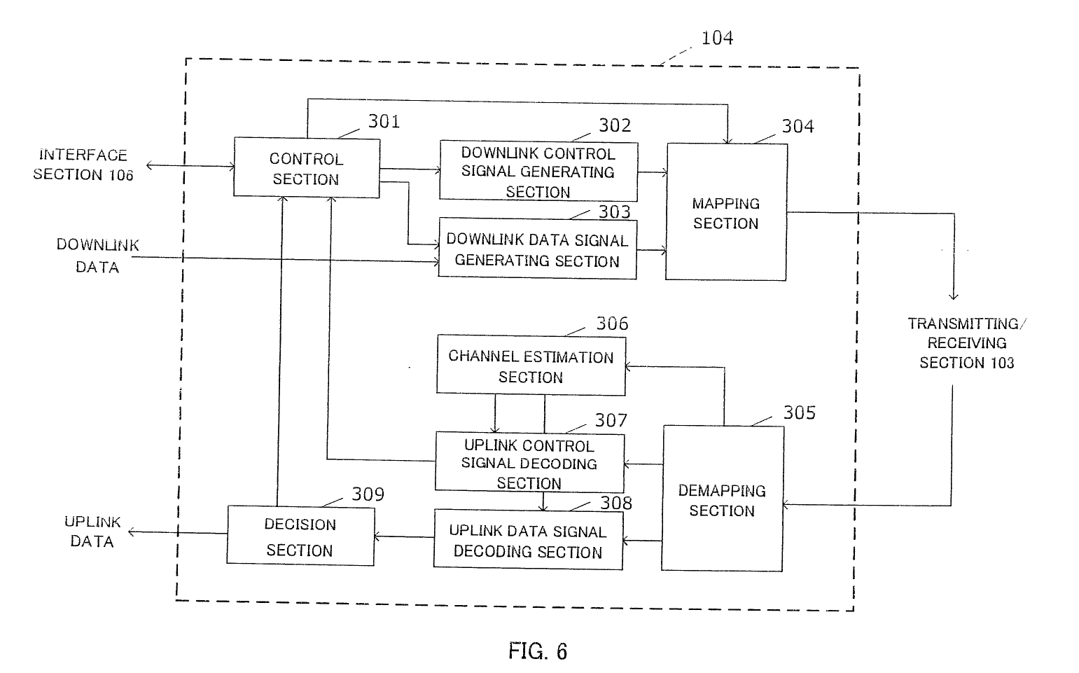

FIG. 6 is a diagram to show a principle functional structure of the baseband signal processing section 104 provided in the radio base station 10 according to the present embodiment. As shown in FIG. 6, the baseband signal processing section 104 provided in the radio base station 10 is comprised at least of a control section 301, a downlink control signal generating section 302, a downlink data signal generating section 303, a mapping section 304, a demapping section 305, a channel estimation section 306, an uplink control signal decoding section 307, an uplink data signal decoding section 308 and a decision section 309.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling of RA preambles communicated in the PRACH, uplink data that is communicated in the PUSCH, uplink control information that is communicated in the PUCCH or the PUSCH, and uplink reference signals (allocation control). Information about the allocation control of uplink signals (uplink control signals, uplink user data, etc.) is reported to the user terminals 20 by using a downlink control signal (DCI).

The control section 301 controls the allocation of radio resources to downlink signals and uplink signals based on command information from the higher station apparatus 30, feedback information from each user terminal 20 and so on. That is, the control section 301 functions as a scheduler. For the control section 301, a controller, a control circuit or a control device that can be described based on common understanding of the technical field to which the present invention pertains can be used.

The control section 301 controls the transmission and receipt of signals in licensed bands or unlicensed bands. When a PRACH that is transmitted in an unlicensed band in random access procedures is received in the transmitting/receiving sections 103, the control section 301 may control the step of transmitting a random access response and the subsequent steps of random access procedures to be performed in a licensed band.

The downlink control signal generating section 302 generates downlink control signals (which may be both PDCCH signals and EPDCCH signals, or may be one of these) that are determined to be allocated by the control section 301. To be more specific, the downlink control signal generating section 302 generates downlink assignments, which report downlink signal allocation information, and uplink grants, which report uplink signal allocation information, based on commands from the control section 301. For the downlink control signal generating section 302, a signal generator or a signal generating circuit that can be described based on common understanding of the technical field to which the present invention pertains can be used.

The downlink data signal generating section 303 generates downlink data signals (PDSCH signals) that are determined to be allocated to resources by the control section 301. The data signals that are generated in the data signal generating section 303 are subjected to a coding process and a modulation process, based on coding rates and modulation schemes that are determined based on CSI from each user terminal 20 and so on.

The mapping section 304 controls the allocation of the downlink control signals generated in the downlink control signal generating section 302 and the downlink data signals generated in the downlink data signal generating section 303, to radio resources, based on commands from the control section 301. For the mapping section 304, a mapping circuit or a mapper that can be described based on common understanding of the technical field to which the present invention pertains can be used.

The demapping section 305 demaps the uplink signals transmitted from the user terminals 20 and separates the uplink signals. The channel estimation section 306 estimates channel states from the reference signals included in the received signals separated in the demapping section 305, and outputs the estimated channel states to the uplink control signal decoding section 307 and the uplink data signal decoding section 308.

The uplink control signal decoding section 307 decodes the feedback signals (delivery acknowledgement signals and/or the like) transmitted from the user terminals in the uplink control channel (PRACH, PUCCH, etc.), and outputs the results to the control section 301. The uplink data signal decoding section 308 decodes the uplink data signals transmitted from the user terminals through an uplink shared channel (PUSCH), and outputs the results to the decision section 309. The decision section 309 makes retransmission control decisions (A/N decisions) based on the decoding results in the uplink data signal decoding section 308, and outputs the results to the control section 301.

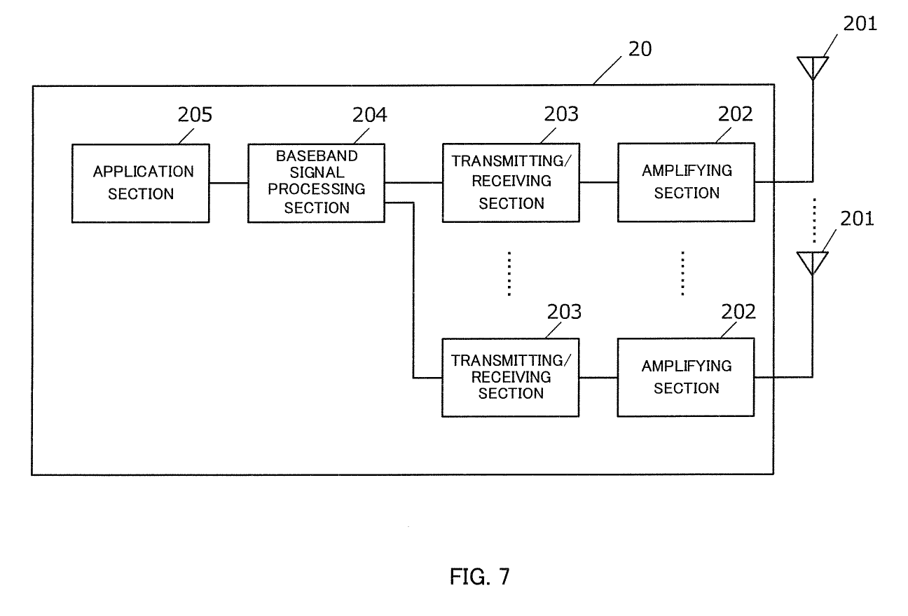

FIG. 7 is a diagram to show an overall structure of a user terminal 20 according to the present embodiment. As shown in FIG. 7, the user terminal 20 has a plurality of transmitting/receiving antennas 201 for MIMO communication, amplifying sections 202, transmitting/receiving sections (transmitting sections and receiving sections) 203, a baseband signal processing section 204 and an application section 205.

As for downlink data, radio frequency signals that are received in the plurality of transmitting/receiving antennas 201 are each amplified in the amplifying sections 202, and subjected to frequency conversion and converted into the baseband signal in the transmitting/receiving sections 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Furthermore, in the downlink data, broadcast information is also forwarded to the application section 205. For the transmitting/receiving sections 203, transmitters/receivers, transmitting/receiving circuits or transmitting/receiving devices that can be described based on common understanding of the technical field to which the present invention pertains can be used.

Meanwhile, uplink user data is input from the application section 205 to the baseband signal processing section 204. In the baseband signal processing section 204, a retransmission control (HARQ) transmission process, channel coding, precoding, a discrete Fourier transform (DFT) process, an inverse fast Fourier transform (IFFT) process and so on are performed, and the result is forwarded to transmitting/receiving section 203. The baseband signal that is output from the baseband signal processing section 204 is converted into a radio frequency band in the transmitting/receiving sections 203. After that, the amplifying sections 202 amplify the radio frequency signals having been subjected to frequency conversion, and transmit the resulting signals from the transmitting/receiving antennas 201.

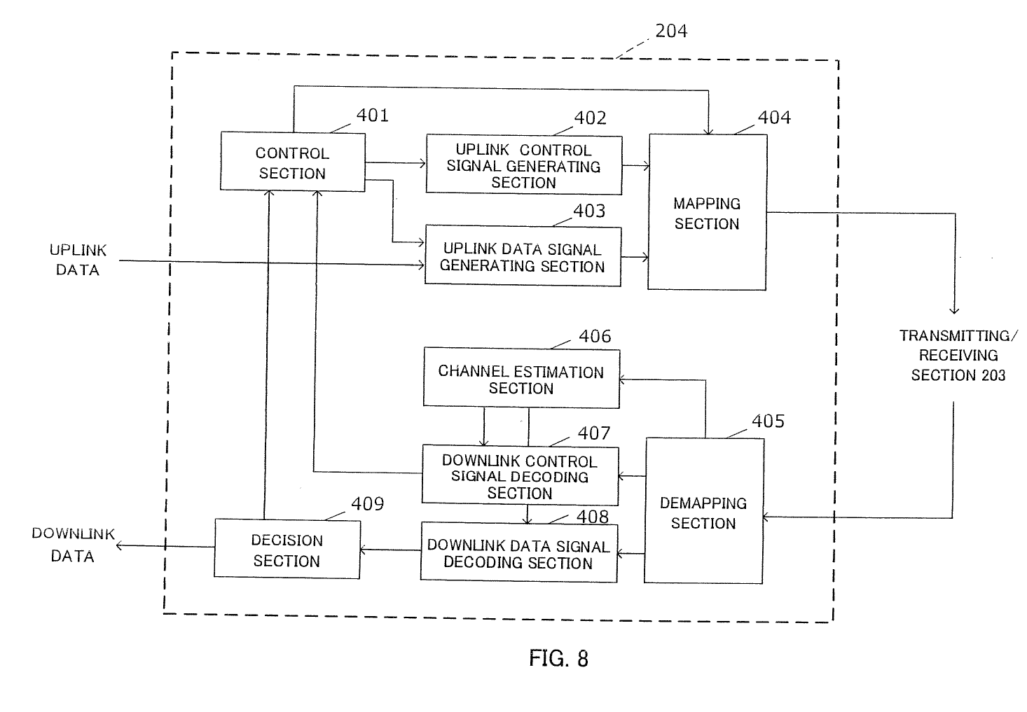

FIG. 8 is a diagram to show a principle functional structure of the baseband signal processing section 204 provided in the user terminal 20. As shown in FIG. 8, the baseband signal processing section 204 provided in the user terminal 20 is comprised at least of a control section 401, an uplink control signal generating section 402, an uplink data signal generating section 403, a mapping section 404, a demapping section 405, a channel estimation section 406, a downlink control signal decoding section 407, a downlink data signal decoding section 408 and a decision section 409.

The control section 401 controls the generation of uplink control signals (A/N signals, etc.), uplink data signals and so on, based on the downlink control signals (PDCCH signals) transmitted from the radio base stations 10, retransmission control decisions in response to the PDSCH signals received, and so on. The downlink control signals received from the radio base stations are output from the downlink control signal decoding section 408, and the retransmission control decisions are output from the decision section 409. For the control section 401, a controller, a control circuit or a control device that can be described based on common understanding of the technical field to which the present invention pertains can be used.

The control section 401 controls the transmission and receipt of signals in licensed bands or unlicensed bands. The control section 401 may control the step of receiving a random access response and the subsequent steps of random access procedures to be performed in a licensed band, and, furthermore, control uplink transmission to be made in an unlicensed band after random access is established. The control section 401 may control the physical random access channel (PRACH) alone to be transmitted in an unlicensed band in random access procedures. The control section 401 may control the random access procedures to be performed in a licensed band CC in a timing advance group (TAG) including licensed band CCs and unlicensed band CCs, and, furthermore, control uplink transmission to be made in an unlicensed band after random access is established.

The uplink control signal generating section 402 generates uplink control signals (feedback signals such as delivery acknowledgement signals, channel state information (CSI) and so on) based on commands from the control section 401. The uplink data signal generating section 403 generates uplink data signals based on commands from the control section 401. Note that, when an uplink grant is contained in a downlink control signal reported from a radio base station, the control section 401 commands the uplink data signal 403 to generate an uplink data signal. For the uplink control signal generating section 402, a signal generator or a signal generating circuit that can be described based on common understanding of the technical field to which the present invention pertains can be used.

The mapping section 404 controls the allocation of the uplink control signals (delivery acknowledgment signals and so on) and the uplink data signals to radio resources (PUCCH, PUSCH, etc.) based on commands from the control section 401.

The demapping section 405 demaps the downlink signals transmitted from the radio base station 10 and separates the downlink signals. The channel estimation section 407 estimates channel states from the reference signals included in the received signals separated in the demapping section 406, and outputs the estimated channel states to the downlink control signal decoding section 407 and the downlink data signal decoding section 408.

The downlink control signal decoding section 407 decodes the downlink control signals (PDCCH signals) transmitted in the downlink control channel (PDCCH), and outputs the scheduling information (information regarding the allocation to uplink resources) to the control section 401. Also, when information related to the cell to feed back delivery acknowledgement signals or information as to whether or not to apply RF tuning is included in the downlink control signals, these pieces of information are also output to the control section 401.

The downlink data signal decoding section 408 decodes the downlink data signals transmitted in the downlink shared channel (PDSCH), and outputs the results to the decision section 409. The decision section 409 makes retransmission control decisions (A/N decisions) based on the decoding results in the downlink data signal decoding section 408, and outputs the results to the control section 401.

Note that the present invention is by no means limited to the above embodiments and can be carried out with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosure of Japanese Patent Application No. 2014-225846, filed on Nov. 6, 2014, including the specification, drawings and abstract, is incorporated herein by reference in its entirety.

1. A user terminal comprising a control section that controls transmission and receipt of a signal in a first frequency carrier in which LBT (Listen Before Talk) is configured or in a second frequency carrier in which LBT is not configured,
wherein the control section controls a step of receiving a random access response and subsequent steps in random access procedures to be performed in the second frequency carrier, and, furthermore, controls uplink transmission to be carried out in the first frequency carrier after random access is established.

2. The user terminal according to claim 1, wherein the control section controls only a physical random access channel (PRACH) to be executed in the first frequency carrier in the random access procedures.

3. The user terminal according to claim 2, wherein the PRACH is a contention-based PRACH.

4. The user terminal according to claim 1, wherein, in a timing advance group (TAG) including a component carrier of the first frequency carrier and a component carrier of the second frequency carrier, the control section controls the random access procedures to be performed in the component carrier of the second frequency carrier.

5. The user terminal according to claim 1, further comprising a receiving section that receives control information for distinguishing between the component carrier of the first frequency carrier and the component carrier of the second frequency carrier.

6. The user terminal according to claim 4, wherein the control section controls a timing reference cell to be configured in the component carrier of the second frequency carrier.

7. The user terminal according to claim 1, wherein the control section controls capability information, which indicates whether or not LBT can be executed in a predetermined frequency carrier, to be reported.

8. A radio base station comprising:
a control section that controls transmission and receipt of a signal in a first frequency carrier in which LBT (Listen Before Talk) is configured or a second frequency carrier in which LBT is not configured; and
a transmitting/receiving section,
wherein, when a PRACH that is transmitted in the first frequency carrier is received in the transmitting/receiving section in random access procedures, the control section controls a step of transmitting a random access response and subsequent steps in the random access procedures to be performed in the second frequency carrier.

9. A radio communication system comprising a radio base station and a user terminal, communicating by using a first frequency carrier in which LBT (Listen Before Talk) is configured and a second frequency carrier in which LBT is not configured, wherein:
the user terminal comprises a control section that controls transmission and receipt of a signal in the first frequency carrier or in the second frequency carrier;
the control section controls a physical random access channel (PRACH) to be transmitted in the first frequency carrier in random access procedures, and controls a step of receiving a random access response and subsequent steps to be performed in the second frequency carrier, and, furthermore, controls uplink transmission to be carried out in the first frequency carrier after random access is established;
the radio base station comprises a control section that controls the transmission and receipt of signals in the first frequency carrier or the second frequency carrier, and a transmitting/receiving section; and
when the PRACH that is transmitted in the first frequency carrier is received in the transmitting/receiving section in the random access procedures, the control section controls a step of transmitting the random access response and subsequent steps in the random access procedures to be performed in the second frequency carrier.

10. A radio communication method for a user terminal that can communicate with a radio base station by using a first frequency carrier in which LBT (Listen Before Talk) is configured and a second frequency carrier in which LBT is not configured, the radio communication method comprising the steps of controlling transmission and receipt of a signal in the first frequency carrier or in the second frequency carrier,
wherein, in the above steps, the step of receiving a random access response and subsequent steps in random access procedures are controlled to be performed in the second frequency carrier, and, furthermore, uplink transmission is controlled to be carried out in the first frequency carrier after random access is established.

11. The user terminal according to claim 2, further comprising a receiving section that receives control information for distinguishing between the component carrier of the first frequency carrier and the component carrier of the second frequency carrier.

12. The user terminal according to claim 3, further comprising a receiving section that receives control information for distinguishing between the component carrier of the first frequency carrier and the component carrier of the second frequency carrier.

13. The user terminal according to claim 4, further comprising a receiving section that receives control information for distinguishing between the component carrier of the first frequency carrier and the component carrier of the second frequency carrier.
